(19) United States
(12) Patent Application Publication
(10) Pub. No.: US 2008/0040897 A1
(43) Pub. Date: Feb. 21, 2008

(54) Inside loop clamp

(76) Inventor: Erwin L. Schaub, Jacksonville, FL (US)

Correspondence Address: Epicor Industries, Inc.;c/o The Gates Corporation, IP Law Dept. 10-A3, 1551 Wewatta Street, Denver, CO, 80202, US

(21) Appl. No.: 11/507,357

(22) Filed: Aug. 21, 2006

(51) Int. Cl. F16L 33/00

(52) U.S. Cl. 24/20 R

(57) ABSTRACT

An inside loop hose clamp includes a band member encircling a hose to impart inward directed compressive force to seal the hose to a fitting. A first loop is defined by the first band end portion encompassing a head of a fastener. A distal end of the first band end portion is secured to the inward facing surface of the band member. A second loop is defined by the second band end portion that encompasses an annular trunnion adapted to receive the shank of the fastener. A distal end of the second band end portion is secured to the inward facing surface of the band member. A threaded portion of the shank of the fastener receives a nut and tightening of the nut imparts the inward directed compressive force to seal the hose to the fitting and to retain the distal ends of the band end portions.

### BACKGROUND OF THE INVENTION

1. Field of the Invention

This invention relates generally to hose clamps, more particularly to hose clamps of the “T”-bolt variety and, and specifically, to an inside loop configuration that can be used in rectangular or circular “T”-bolt clamps.

2. Description of the Prior Art

Hose clamps are conventionally employed to seal the connection between a hose or tubing and a corresponding structure or fitting. The clamp typically encircles at least a portion of the outer circumference of the hose or tubing disposed about the structure or fitting, and is constricted, such as to impart inwardly directed compressive force to seal the hose or tube to the structure or fitting.

Hose clamps of the “T”-bolt variety are known in the art. The present Inventor holds U.S. Pat. Nos. 6,584,654 and 6,691,379, directed for improvements related to “T”-bolt hose clamps. The disclosures of these patents are incorporated herein by reference thereto. The utilization of “T”-bolt clamps presents many advantages over other types of hose clamp, including that of being generally adjustable over a range of hose diameters and of accommodating relatively higher loads than other clamp types, such as those employing worm-type or screw connections, or deformable ear type constricting members.

“T”-bolt clamps conventionally include a band portion encircling the greater portion of a hose or tube exterior and opposing ends bent radially outward and upon themselves to form opposing looped band ends. A “T”-bolt, extending between the opposed looped band ends, through apertures therein, may be tightened to force the looped ends to draw toward one another thus reducing the band's circumference to constrict the band about the hose or tube.

FIGS. 1 and 2 show typical prior art rectangular “T”-bolt clamp 100 and circular “T”-bolt clamp 200, constructed using welds 101 or 201, typically resistance type spot welds, to secure looped over lengths 103 or 203 of clamp band material 105 or 205 to exterior surface 107 or 207 of band 105 or 205. For purposes of illustration herein welds joining two portions of band material, such welds 101 and 201, are indicated at the interface of the joined bands. However, such welds are a part of each of the joined portions and would not typically be visible.

Problematically, and particularly problematic in rectangular clamps such as clamp 100, when clamp 100 or 200 is used to clamp two bodies together, looped over material 103 or 203 is welded to the outside of the tension carrying portion of band 105 or 205. This results in distortion of tension carrying band 105 or 205 as the clamp is tightened. This distortion is particularly evident in typical rectangular “T”-bolt clamps, similar to as illustrated in prior art FIG. 3. In FIG. 3 tension band 105 can be shown distorting as bolt tension draws band material around the corners 311 of object 310 being clamped, during tightening. As band material is pulled around corners 311 it pulls side lengths 312 and 313 of band 105 away from object 310, resulting in bends 315 and 316 at welds 101. Typically, bends 315 and 316 occur at welds 101 as that is the point where the double thickness upper bands and the single thickness lower band meet. A bend at a weld, such as bends 315 and 316, typically causes cracks at that location, possibly in both the band and the welds. These cracks are prone to propagate and cause band separation or breakage, particularly when exacerbated by operational vibration and/or cyclic loading.

Stresses and/or failure similar to those discussed above may be evident in conventional circular “T”-bolt clamps, but may not be as readily apparent. For example, during tightening the circumference and diameter of a clamp is reduced which may result in uneven stresses at the welds and/or distortions of the band at the welds, similar to those described above. These stresses and failures may be more prevalent in clamps manufactured and shipped in a flat configuration and then formed into a circular shape in the field.

The incorporation of a bridge member in “T”-bolt clamp constructions is known. Such bridge constructions might include a generally resilient thin shorter length strip extending along an outer circumference of a hose, between the outer band's opposed band ends, and radially inward of the “T”-bolt. These bridge members have been employed in “T”-bolt clamp configurations for preventing or reducing the incidence of the formation of a bulge, or a portion of the hose wall from moving radially away from the underlying fitting in the region between the band's looped ends as a consequence of the looped ends being drawn together during the clamp tightening process. However, these or other structures fail to address distortion of the sides of the clamps, or uneven loading of the clamp bands, at the welds during tightening and/or during operation, and subsequent possible failure of the welds and/or surrounding band material.

### SUMMARY

The present invention is directed to systems and methods which provide a clamp employing an inside loop configuration that is particularly well suited for use with rectangular or circular “T”-bolt clamps, or the like, to overcome clamp failure due to distortion of the clamp band at welds.

Embodiments of the present clamps include an integral band member adapted to encircle at least a portion of the exterior of a hose to impart inward directed compressive force to seal the hose to a fitting. The band member has an outward facing surface, an inward facing surface and a length extending from a first band end portion to an opposite second end portion. Various embodiments of the present invention make the loops defined in the ends of the clamp band internal to the clamp. In such embodiments a first loop is defined by the first band end portion, encompassing a head of a fastener. The first band end portion preferably passes over the head of the fastener, and also defines a slot for passage of a shank of the fastener. A distal end of the first band end portion is secured to the inward facing surface of the band member in accordance with embodiments of the present invention. A second loop may be defined by the second band end portion and may encompass an annular trunnion adapted to receive the shank of the fastener. The second band end portion might also pass over the trunnion and define at least one slot for passage of the shank. In accordance with embodiments of the present invention, a distal end of the second band end portion is secured to the inward facing surface of the band member.

Thus, an embodiment of a method for clamping a hose or the like to a structure, fitting, or the like might employ a clamp that encompasses a head of a fastener with a first loop defined by a first end portion of a clamping band. A distal end of the first end portion may be secured to an inward facing surface of the band member, while a trunnion receiving a shank of the fastener might be encompassed with a second loop defined by a second end portion of the clamping band and a distal end of the second end portion is secured to the inward facing surface of the band member. Threading a nut onto the fastener and tightening the nut against the trunnion preferably imparts inward directed compressive force via the band to seal the hose to the fitting, structure, or the like. Although when thus configured, the band might still bulge when tightened, the exterior band is a continuous band and when the band bulges during tightening the welds securing the distal ends of the band to the interior of the band do not tend to separate from the band as in typical clamps of prior designs. Thus, the welds and/or surrounding band material do not crack. As a result a fatigue failure, such as may develop as the result of vibration and/or cyclic loading, may not be afforded a starting point.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a side view of a typical prior art rectangular “T”-bolt clamp;

FIG. 2 is a side view of a typical prior art circular “T”-bolt clamp;

FIG. 3 is a side view the typical prior art rectangular “T”-bolt clamp of FIG. 1 under tension, showing distortion at the welds;

FIG. 4 is a side view of a rectangular embodiment of the present clamp; and;

FIG. 5 is a side view of a circular embodiment of the present clamp.

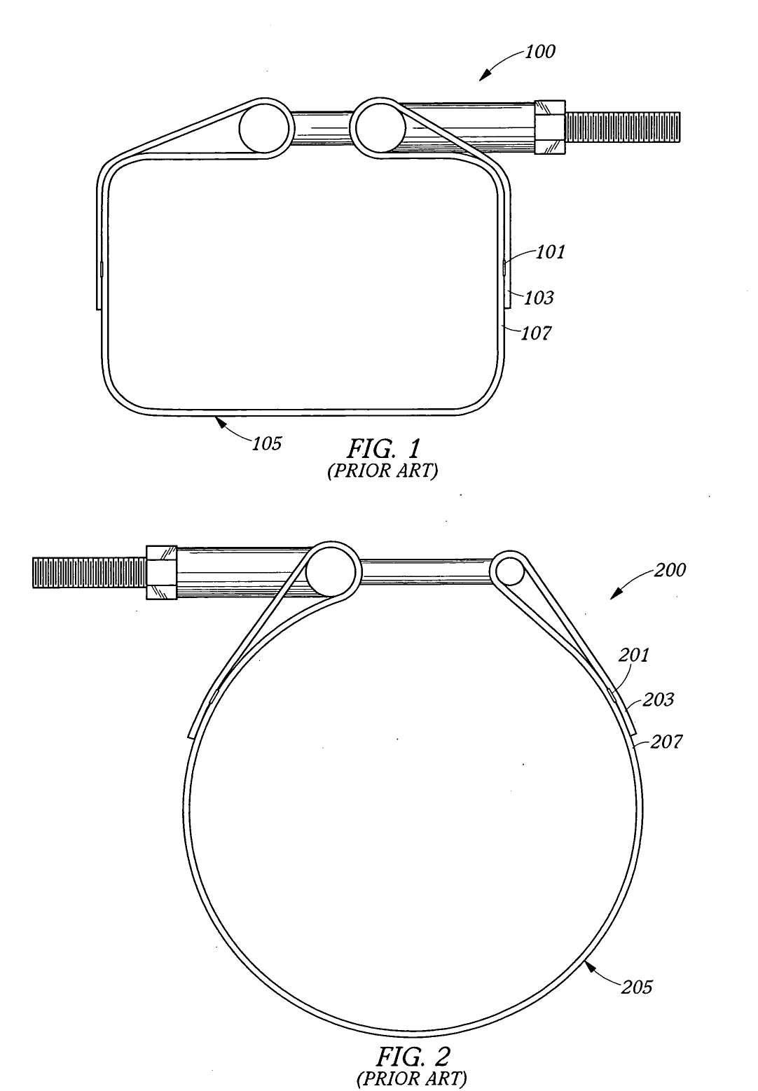

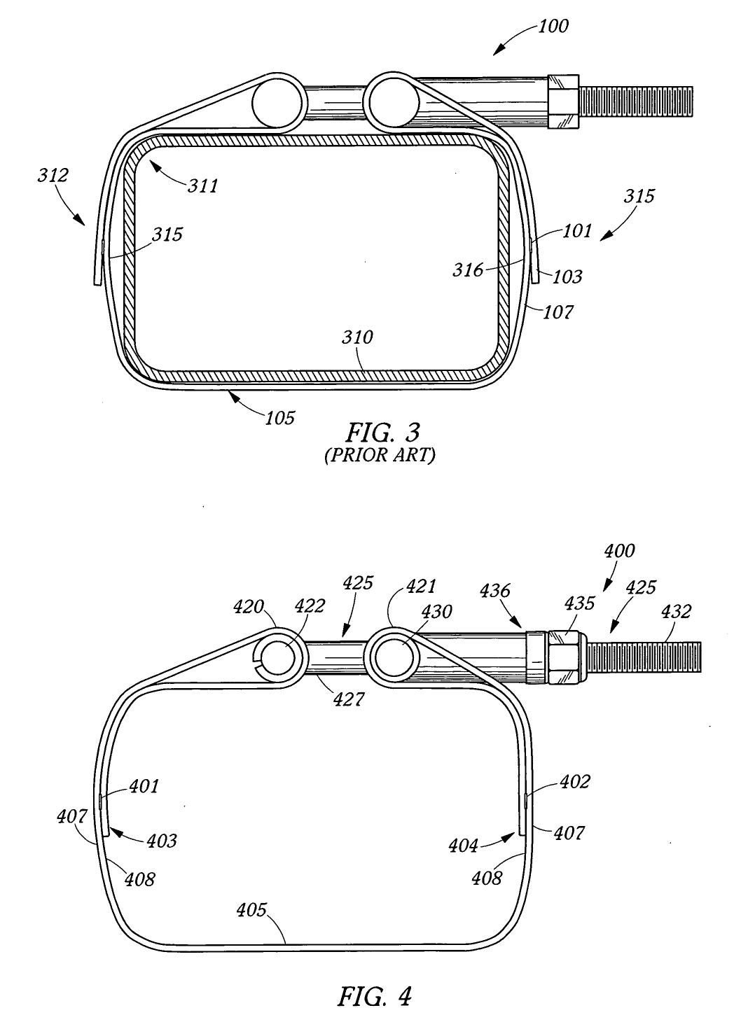

### DETAILED DESCRIPTION

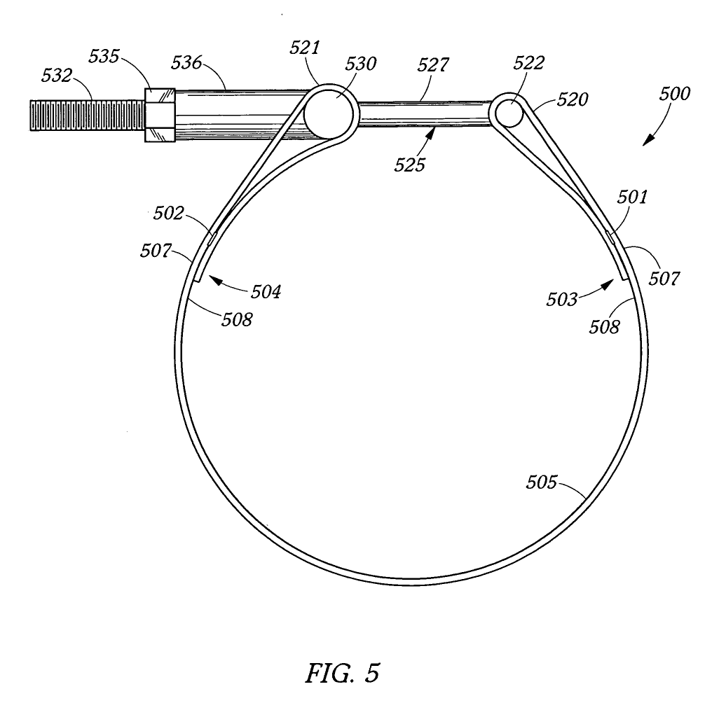

An embodiment of a rectangular “T”-bolt clamp (400) employing loops 420 and 421 defined in the ends 403 and 404, respectively, of clamp band 405 internal to the clamp is illustrated in FIG. 4. A similar circular “T”-bolt clamp embodiment (500) employing loops 520 and 521 defined in ends 503 and 504, respectively, of clamp band 505 internal to the clamp is illustrated in FIG. 5. Each of clamp embodiments 400 and 500 include integral band member 405 or 505 adapted to encircle at least a portion of the exterior of a hose or the like to impart inward directed compressive force to seal the hose to a fitting. Band members 405 and 505 each have an outward facing surface, 407 or 507, and an inward facing surface 408 or 508. Each end of band 405 or 505 ends in an end band portion 403 and 404 or 503 and 504 as shown in FIGS. 4 and 5.

In each of embodiments 400 and 500 first loop 420 or 520 is defined by first band end portion 403 or 503. In the “T”-bolt embodiments of FIGS. 4 and 5, loop 420 or 520 encompasses head 422 or 522 of fastener 425 or 525. In particular, first band end portion 420 or 520 preferably passes over and around head 422 or 522 of fastener 425 or 525. In “T”-bolt embodiments 400 and 500 end portions 403 and 503 also define a slot (not shown in the side views of FIGS. 4 and 5) that may allow passage of shank 427 or 527 of fastener 425 or 525. A distal end of first band end portion 403 or 503 is secured to inward facing surface 408 or 508 of the band member in accordance with embodiments of the present invention by resistance spot weld(s) 401 or similar means.

In embodiments such as “T”-bolt clamps 400 and 500 of FIGS. 4 and 5, second loop 421 or 521 may be defined by second band end portion 404 or 504 and may encompass annular trunnion 430 or 530. Preferably, annular trunnion 430 or 530 is adapted to receive shank 427 or 527 of fastener 425 or 525. Second band end portion 421 or 521 in embodiments 400 and 500 passes over the trunnion. Second band end portion 421 or 521 also defines a slot (not shown in the side views of FIGS. 4 and 5) for passage of shank 427 or 527, and may define two slots in some embodiments, one to receive shank 427 or 527 and one to allow passage of threaded portion 432 or 532 of fastener shank 427 or 527, respectively, out of trunnion 430 or 530. In accordance with embodiments 400 and 500 of the present invention, a distal end of second band end portion 404 or 504 is secured to the inward facing surface 408 or 508 of band member 405 or 505 by spot weld(s) 402, or the like.

An embodiment of a method for clamping a hose or the like to a structure, fitting, or the like might employ clamp 400 or 500. Nut 435 or 535 is threaded on threaded shank 432 or 532 of shank 427 or 527 of fastener 425 or 525. Tightening of nut 435 or 535 against trunnion 430 or 530, possibly via ferrules 436 or 536, imparts inward directed compressive force via band 405 or 505 to seal an encompassed hose or the like to a fitting, structure, or the like. Although bands 405 or 505 of embodiments of a clamp such as embodiment 400 and 500 might still bulge when nut 435 or 535 is tightened, the exterior portion of band 405 or 505 is continuous. Thus, if band 405 or 505 bulges during tightening, the distal ends 403, 404, 503 and 504 of the band are retained and do not tend to separate from the band at welds 401,402, 501 or 502, as in typical clamps of prior designs. Thus, cracks are less likely to be imparted into welds 401,402, 501 or 502 and/or surrounding band material.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. As but one example, the present invention might be employed in a “barrels-and-bolt” band-type clamp, wherein a bolt passes through a trunnion captured in one of the in ward loops. The bolt may be either threaded into a threaded trunnion captured by the second inward loop or it may pass through a second unthreaded trunnion captured in the second inward loop and be threaded into a nut on the other side of the second trunnion. Such a nut may be secured against rotation. Accordingly, the appended claims are intended to include within their scope such processes, machines, manufacture, compositions of matter, means, methods, or steps.

What is claimed is:

1. A hose clamp comprising:
an integral band member adapted to encircle at least a portion of the exterior of a hose to impart inward directed compressive force to seal said hose to a fitting, said band member comprising an outward facing surface, an inward facing surface and a length extending from a first band end portion to an opposite second end portion;
a first loop defined by said first band end portion, said first loop adapted to retain a first part of a fastener, a distal end of said first band end portion secured to said inward facing surface of said band member; and
a second loop defined by said second band end portion, said second loop adapted to employ a second part of said fastener to adjustably impart said inward directed compressive force, a distal end of said second band end portion secured to said inward facing surface of said band member.

2. The clamp of claim 1 wherein tightening of said second part of said fastener imparts said inward directed compressive force to seal said hose to said fitting and to retain said distal ends of said band end portions.

3. The clamp of claim 1 wherein said first loop encompasses a head of said first part of a fastener.

4. The clamp of claim 3 wherein first loop passes over said head of said first part of said fastener and defines a slot for passage of a shank of said fastener.

5. The clamp of claim 4 wherein said second loop encompasses an annular trunnion adapted to receive said shank of said first part of said fastener.

6. The clamp of claim 5 wherein said second band end portion passes over said trunnion and defines at least one slot for passage of said shank.

7. The clamp of claim 1 wherein said first part of said fastener is a threaded trunnion.

8. The clamp of claim 7 wherein said second loop encompasses an annular trunnion adapted to receive the shank of bolt comprising said second part of said fastener, said bolt adapted to be threaded into said threaded trunnion.

9. The clamp of claim 1 wherein said distal end of said first band end portion and said distal end of said second band end portion are secured to said inward facing surface of said band member by a weld.

10. The clamp of claim 9 wherein said weld is a resistance spot weld.

11. A hose clamp comprising:
an integral band member adapted to encircle at least a portion of the exterior of a hose to impart inward directed compressive force to seal said hose to a fitting, said band member comprising an outward facing surface, an inward facing surface and a length extending from a first band end portion to an opposite second end portion;
a first loop defined by said first band end portion encompassing a head of a fastener, said first band end portion passing over said head of said fastener and defining a slot for passage of a shank of said fastener, a distal end of said first band end portion secured to said inward facing surface of said band member; and
a second loop defined by said second band end portion encompassing an annular trunnion adapted to receive said shank of said fastener, said second band end portion passing over said trunnion and defining at least one slot for passage of said shank, a distal end of said second band end portion secured to said inward facing surface of said band member.

12. The clamp of claim 11 wherein a threaded portion of said shank of said fastener receives a nut and tightening of said nut imparts said inward directed compressive force to seal said hose to said fitting and to retain said distal ends of said band end portions.

13. The clamp of claim 12 wherein said inward directed compressive force retaining said distal ends of said band end portions prevents cracks in said band.

14. The clamp of claim 12 wherein said distal end of said first band end portion and said distal end of said second band end portion are secured to said inward facing surface of said band member by a weld.

15. The clamp of claim 14 wherein said weld is a resistance spot weld.

16. The clamp of claim 15 wherein said inward directed compressive force retaining said distal ends of said band end portions prevents cracks in said weld.

17. A method comprising:
encompassing a head of a fastener with a first loop defined by a first end portion of a clamping band;
securing a distal end of said first end portion to an inward facing surface of said band member;
encompassing a trunnion that receives a shank of said fastener with a second loop defined by a second end portion of said clamping band; and,
securing a distal end of said second end portion to said inward facing surface of said band member.

18. The method of claim 15 further comprising:
threading a nut onto said fastener and tightening said nut against said trunnion to impart inward directed compressive force by said band and to retain said distal ends of said band end portions.

19. The method of claim 16 wherein said inward directed compressive force retaining said distal ends of said band end portions prevents cracks in said band.

20. The method of claim 16 wherein said securing comprises welding respective ones of said end portions to said inward facing surface of said clamping band and said inward directed compressive force retaining said distal ends of said band end portions prevents cracks in the resulting welds.

21. The method of claim 15 further comprising:
defining a slot in said first end portion for passage of said shank of said fastener.

22. The method of claim 15 further comprising:
defining at least one slot in said second end portion for passage of said shank of said fastener, through said trunnion.

23. A method comprising:
encompassing a unthreaded trunnion with a first loop defined by a first end portion of a clamping band;
securing a distal end of said first end portion to an inward facing surface of said band member;
passing a bolt through said unthreaded trunnion;
encompassing a threaded trunnion with a second loop defined by a second end portion of said clamping band;
securing a distal end of said second end portion to said inward facing surface of said band member; and
threading said bolt into said threaded trunnion such that tightening said bolt against said unthreaded trunnion imparts inward directed compressive force by said band and retains said distal ends of said band end portions.

24. The method of claim 23 wherein said inward directed compressive force retaining said distal ends of said band end portions prevents cracks in said band.

25. The method of claim 23 wherein said securing comprises welding respective ones of said end portions to said inward facing surface of said clamping band and said inward directed compressive force retaining said distal ends of said band end portions prevents cracks in the resulting welds.

26. The method of claim 23 further comprising:
defining at least one slot in said end portions for passage of a shank of said bolt.
